(19) United States
(12) Patent Application Publication
(10) Pub. No.: US 2012/0193493 A1
(43) Pub. Date: Aug. 2, 2012

(54) RAIL VEHICLE HAVING AN INSTALLATION HOUSING SECURED BY MEANS OF A BRACKET

(76) Inventor: Klaus Rekasch, Rheurdt (DE)

(21) Appl. No.: 13/018,698

(22) Filed: Feb. 1, 2011

(51) Int. Cl. F16B 2/02; F16M 13/02

(52) U.S. Cl. 248/226.11; 248/205.1

(57) ABSTRACT

A rail vehicle with at least one installation housing secured to a car body of the rail vehicle by a bracket is provided. The bracket is secured to the housing in a height-adjustable manner.

### FIELD OF INVENTION

The invention relates to a rail vehicle having at least one installation housing which is secured to a car body of the rail vehicle by means of a bracket.

### SUMMARY OF INVENTION

Such installation housings can contain for example an air-conditioning unit, but generally also electrical components of any kind.

The brackets for securing an installation housing to a car body, typically in the roof area thereof, are mounted in a fixed manner on the installation housings. In this case, the tolerances occurring on the vehicle roof have to be compensated beneath the brackets. This has been done hitherto by underlaying suitable metal sheets, which is considered to be a complex method, however.

An object of the invention is to further develop a rail vehicle of the type mentioned at the beginning in such a way that the mounting of the installation housing is simplified.

In the case of such a rail vehicle, this object is achieved in that the bracket is secured to the housing in a height-adjustable manner.

The bracket can in this case be secured to the housing in a form-fitting and/or force-fitting manner. In particular, it is not absolutely necessary for the opposing surfaces of the bracket and of the housing to be in engagement. It will be favorable in many cases, however, if an additional force fit is provided between the two components to be connected, namely the bracket and the housing.

For this reason, it is preferred for a stepped toothed segment to be provided on the housing in order to interact with at least one stepped toothed segment on the bracket. Alternatively, other embodiments, which produce a suitable force fit between the bracket and the housing, are also conceivable.

It is favorable if two, in each case external stepped toothed segments are provided on the bracket. These can then engage at the desired height into the toothed segment on the housing.

A clamping screw can be provided to secure the bracket—once it is at the desired height with respect to the housing—to the housing. A further clamping screw can serve to secure the bracket to the car body.

In order to bring the bracket to a suitable height for height adjustment above the car body, it can be provided that the bracket is attached to a panel segment of the car body via an intermediate component.

### BRIEF DESCRIPTION OF THE DRAWINGS

An exemplary embodiment of the invention will be explained in more detail below with reference to the drawing, in which:

FIG. 1 shows a perspective view of a roof area of a rail vehicle having an installation housing to be secured in this area,

FIG. 2 shows a further perspective view of the roof area in FIG. 1, and

FIG. 3 shows a detail view of FIG. 1.

### DETAILED DESCRIPTION OF INVENTION

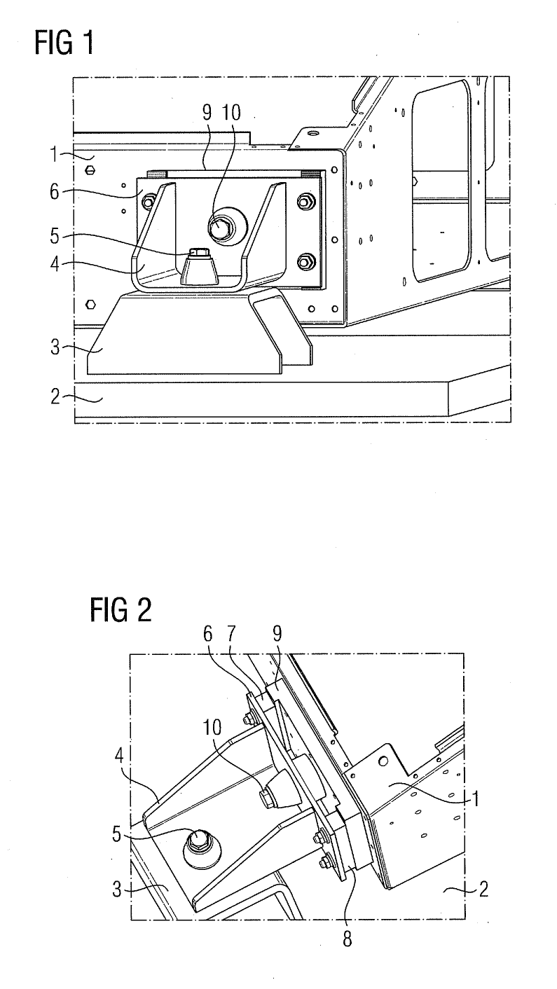

FIG. 1 illustrates the general design for securing an installation housing 1, for example an air-conditioning unit or an E-container, to a roof segment 2 of a rail vehicle. A height-adjustable bracket 4 is attached to the roof segment 2 via an intermediate component 3 extending upwardly from the roof segment 2. The bracket 4 is secured via a clamping screw 5.

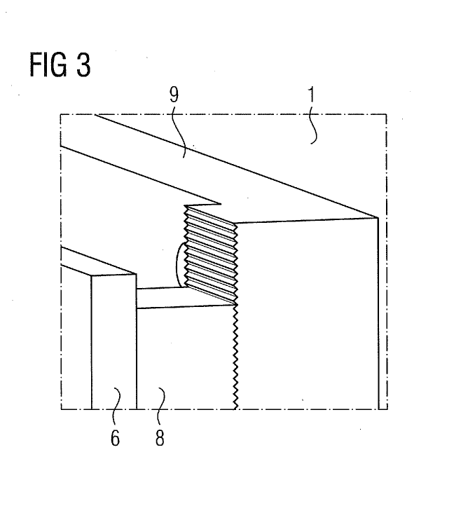

As can be seen in particular in FIGS. 2 and 3, the bracket 4 has an end plate 6 facing the housing 1 to be secured. The end plate 6 bears two vertically and externally arranged stepped toothed segments 7, 8, which are substantially in the form of webs.

The stepped toothed segments 7, 8 are screwed to the end plate 6. The toothed segments 7, 8 interact with a stepped toothed segment 9 on the housing, said toothed segment 9 likewise being provided with toothings in its external regions opposite the toothed segments 7, 8. As long as there is no fixed connection between the housing 1 on the one hand and the bracket 4 on the other, the relative height of the housing 1 with respect to the bracket 4 can be adjusted and fixed by the engagement of the relevant toothed segments 7, 8 and 9. As soon as a desired height has been reached, the bracket 4 is permanently secured to the housing 1 with the aid of a clamping screw 10.

1. A rail vehicle, comprising:
at least one installation housing which is secured to a car body of the rail vehicle by a bracket,
wherein the bracket is secured to the housing in a height-adjustable manner.

2. The rail vehicle as claimed in claim 1,
wherein a stepped toothed segment is provided on the housing in order to interact with at least one stepped toothed segment on the bracket.

3. The rail vehicle as claimed in claim 2,
wherein two, in each case external, stepped toothed segments are provided on the bracket.

4. The rail vehicle as claimed in claim 1, further comprising:
a first clamping screw for securing the bracket to the housing.

5. The rail vehicle as claimed in claim 2, further comprising:
a first clamping screw for securing the bracket to the housing.

6. The rail vehicle as claimed in claim 1, further comprising:
a second clamping screw for securing the bracket to the car body.

7. The rail vehicle as claimed in claim 2, further comprising:
a second clamping screw for securing the bracket to the car body.

8. The rail vehicle as claimed in claim 4, further comprising:
a second clamping screw for securing the bracket to the car body.

9. The rail vehicle as claimed in claim 1, further comprising:
an intermediate component, wherein the bracket is attached to a panel segment of the car body via the intermediate component.

10. The rail vehicle as claimed in claim 2, further comprising:
an intermediate component, wherein the bracket is attached to a panel segment of the car body via the intermediate component.

11. The rail vehicle as claimed in claim 4, further comprising:
an intermediate component, wherein the bracket is attached to a panel segment of the car body via the intermediate component.

12. The rail vehicle as claimed in claim 6, further comprising:
an intermediate component, wherein the bracket is attached to a panel segment of the car body via the intermediate component.
